(19) United States
(12) Patent Application Publication
(10) Pub. No.: US 2021/0162796 A1
(43) Pub. Date: Jun. 3, 2021

(54) NOTEBOOK HANGER

(71) Applicant: World Wide Stationery Mfg. Co., Ltd., Kwai Chung, New Territory (CN)

(72) Inventor: Chun Yuen To, N.T. Hong Kong (CN)

(21) Appl. No.: 16/061,301

(22) PCT Filed: Jun. 13, 2017
(86) PCT No.: PCT/CN2017/088054

§ 371 Date: Jun. 11, 2018

(51) Int. Cl. B42F 13/40; B42F 13/22; B42F 15/00

(52) U.S. Cl. CPC B42F 13/40; B42F 13/22; B42P 2241/16; B42P 2241/10; B42F 15/0064

(57) ABSTRACT

A hanger for hanging a binder containing loose-leaf pages in a hanging drawer system has first and second opposed hooks configured to be secured to a notebook spine. First and second arms are moveable relative to the hooks between extended and retracted positions. The arms have support surfaces that extend laterally beyond the hooks in the extended position and lips that are spaced from the hooks in the extended position. A method of hanging a notebook in a drawer includes moving the arms to the extended position and placing the support surfaces of the arms on the rails of the hanging drawer system so the rails support the notebook.

### CROSS REFERENCE TO RELATED APPLICATION

This application is a US National Stage Application of International Application No. PCT/CN2017/088054, filed Jun. 13, 2017, the entire content of which is hereby incorporated by reference.

### FIELD OF THE INVENTION

The present invention relates generally to loose-leaf notebooks and similar devices used for holding loose-leaf pages, and more particularly to systems and methods for storing such devices in a drawer.

### BACKGROUND

A ring binder mechanism retains loose-leaf pages, such as hole-punched pages, in a file or notebook. Ring binder mechanisms commonly include rings having ring members that can be selectively moved between an open position, for adding or removing pages, and a closed position, for retaining pages on the rings. Ring binder mechanisms are commonly secured to a notebook cover, either on or adjacent the spine of the notebook cover, so the ring binder mechanism can be used to retain loose-leaf pages within the notebook. Notebooks can be stored in various different ways. For example, notebooks can be stored on a shelf in a manner similar to the way regular books are stored on shelves.

One type of storage system that is sometimes used is a hanging file drawer system. A hanging file drawer system typically has two parallel rails extending between and supported by opposite sides of the drawer. The rails are spaced from one another so that file folders containing loose leaf papers to be stored in the drawer can be supported at one end by one of the rails and supported at the opposite end by the other of the rails. This provides efficient storage of file folders while maintaining organization of the loose papers stored in the drawer. It also provides easy access to any of the papers stored in the drawer.

There have been some attempts to devise a system that facilitates storage of ring binder mechanisms and/or notebooks that use ring binder mechanisms in hanging file drawer systems. Some examples of these efforts are provided in U.S. Pat. Nos. 3,801,175; 3,936,201; 4,208,146; 5,199,809; 5,358,125; 5,993,099; 7,445,396; and U.S. Pre-grant Publication No. 2013/0136523 A1.

The present inventor has made various improvements in the field of systems for storing notebooks using hanging file drawer systems, which will be described in detail below.

### SUMMARY

One aspect of the invention is a hanger for hanging a binder containing loose-leaf pages in a hanging drawer system of the type comprising a pair of rails inside the drawer and extending between opposite sides of the drawer. The hanger has a first hook configured to be secured to one end of a spine of the notebook and a second hook opposed to the first hook and configured to be secured to an opposite end of the spine of the notebook. A first arm is moveable relative to the first hook between a retracted position and an extended position. The first arm has a support surface and a lip extending angularly from the support surface. The support surface of the first arm extends laterally beyond the first hook when the first arm is in the extended position. The lip of the first arm is spaced from the first hook by the support surface of the first arm when the first arm is in the extended position. The hanger has a second arm moveable relative to the second hook between a retracted position and an extended position. The second arm has a support surface and a lip extending angularly from the support surface. The support surface of the second arm extends laterally beyond the second hook when the second arm is in the extended position. The lip of the second arm is spaced from the second hook by the support surface of the second arm when the second arm is in the extended position.

Another aspect of the invention is a method of storing a notebook including a notebook cover having a spine in a hanging drawer storage system of the type having a pair of rails mounted inside a drawer. The method includes securing a hanger having first and second hooks to the notebook cover by securing the first hook to one end of the spine and securing the second hook to an opposite end of the spine. A first arm of the hanger is moved from a retracted position to an extended position. The first arm has a support surface and a lip extending angularly from the support surface. The support surface of the first arm extends laterally beyond the first hook when the first arm is in the extended position. The lip of the first arm is spaced from the first hook by the support surface of the first arm when the first arm is in the extended position. A second arm of the hanger is moved from a retracted position to an extended position. The second arm has a support surface and a lip extending angularly from the support surface. The support surface of the second arm extends laterally beyond the second hook when the second arm is in the extended position. The lip of the second arm is spaced from the second hook by the support surface of the second arm when the second arm is in the extended position. The support surfaces of the first and second arms are placed on the rails so the hanger and notebook are supported by the rails.

Other objects and features will be in part apparent and in part pointed out hereinafter.

### BRIEF DESCRIPTION OF THE DRAWINGS

FIG. 1 is a perspective of one embodiment of a hanger of the present invention;

FIG. 2 is another perspective of the hanger illustrated in FIG. 1 from a different vantage point;

FIG. 3 is an exploded perspective of the hanger illustrated in FIGS. 1 and 2;

FIG. 4 is a top plan of the hanger illustrated in FIGS. 1-3;

FIG. 5 is an cross section of the hanger illustrated in FIGS. 1-4 cut along line 5-5 on FIG. 4;

FIG. 6 is an enlarged fragmentary cross section similar to FIG. 5 showing one end of the hanger illustrated in FIGS. 1-5;

FIG. 7 is an enlarged fragmentary cross section similar to FIG. 5 showing the opposite end of the hanger from the end shown in FIG. 6;

FIG. 8 is an enlarged cross section of the hanger illustrated in FIGS. 1-7 taken in a plane including line 8-8 on FIG. 4;

FIG. 9 is an enlarged cross section of the hanger illustrated in FIGS. 1-8 taken in a plane including line 9-9 on FIG. 4;

FIG. 10 is a perspective of the hanger illustrated in FIGS. 1-9 taken from a vantage point that is similar to the perspective in FIG. 1, but showing arms of the hanger in an extended position for supporting the hanger on the rails of a hanging-file system;

FIG. 11 is another perspective of the hanger illustrated in FIGS. 1-10 taken from a vantage point similar to the vantage point in FIG. 2 and showing the arms in the extended position;

FIG. 12 is a side elevation of the hanger illustrated in FIGS. 1-11 showing the arms in the extended position;

FIG. 13 is an enlarged fragmentary cross section similar to FIG. 7 showing one end of the hanger with the arm in the extended position;

FIG. 14 is a perspective of the hanger illustrated in FIGS. 1-13 taken from a vantage point that is similar to FIGS. 1 and 10, but showing the hanger in a configuration in which hooks on the ends of the hanger have been moved away from one another;

FIG. 15 is another perspective of the hanger illustrated in FIGS. 1-14 showing the hanger in the same configuration as FIG. 14 but from a vantage point that is similar to FIGS. 2 and 11;

FIG. 16 is a perspective of one embodiment of an elongate member that is suitable for use as a component of the hanger illustrated in FIGS. 1-15;

FIG. 17 is a top plan of the elongate member illustrated in FIG. 16;

FIG. 18 is a bottom plan of the elongate member illustrated in FIGS. 16 and 17;

FIG. 19 is a perspective of another embodiment of an elongate member that is suitable for use as a component of the hanger illustrated in FIGS. 1-15 and in conjunction with the elongate member illustrated in FIGS. 16-18;

FIG. 20 is a bottom plan of the elongate member illustrated in FIG. 19;

FIG. 21 is another perspective of the hanger illustrated in FIGS. 1-15 similar to FIG. 1, but showing one embodiment of a door of a label display system in an open position;

FIG. 22 is a top plan of the door illustrated in FIG. 21;

FIG. 23 is a perspective of the hanger illustrated in FIGS. 1-15 and 21 secured to the spine of a notebook cover of one embodiment of a notebook having a ring binder mechanism mounted adjacent a spine of the notebook cover;

FIG. 24 is an end view of the hanger and notebook combination illustrated in FIG. 23;

FIG. 25 is a fragmentary cross section of a portion of the hanger and notebook combination illustrated in FIGS. 23 and 24 taken in a plane including line 25-25 on FIG. 24;

FIG. 26 is a perspective of the hanger illustrated in FIGS. 1-15 and 21 secured to the spine of a notebook cover of a different embodiment of a notebook, which has a ring binder mechanism mounted on the spine of the notebook cover instead of adjacent the spine;

FIG. 27 is another perspective of the hanger and notebook combination illustrated in FIG. 22, but showing the hanger in the same configuration as it has in FIGS. 14 and 15 during a step of securing the hanger to the notebook cover; and

FIG. 28 is a side elevation of the hanger and notebook combination of FIGS. 23-25 supported by the rails of a hanging file system.

Corresponding reference characters indicate corresponding parts throughout the drawings.

### DETAILED DESCRIPTION

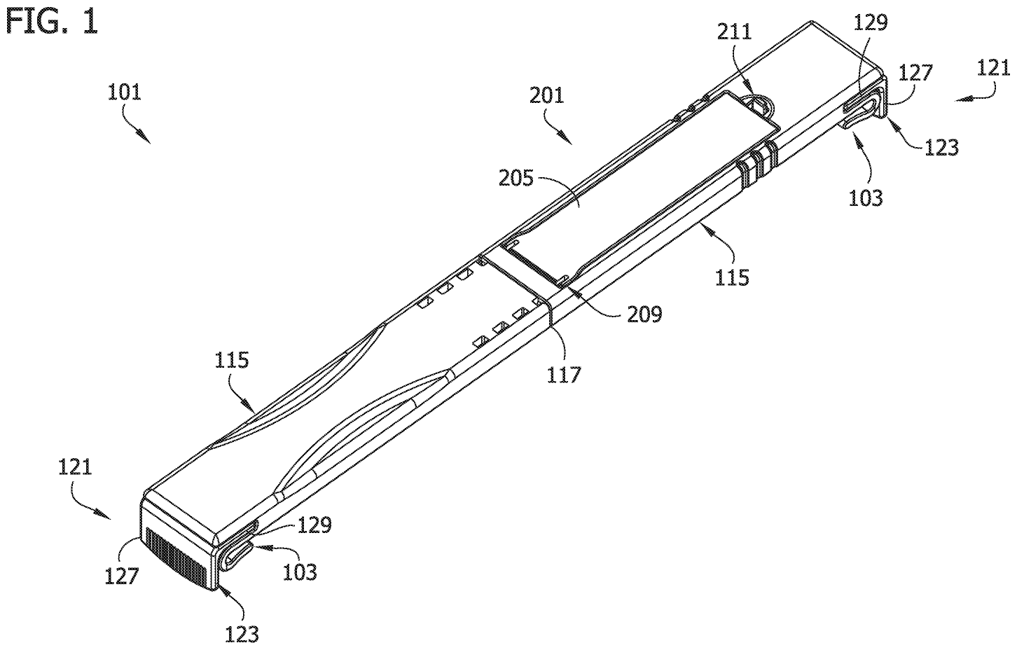

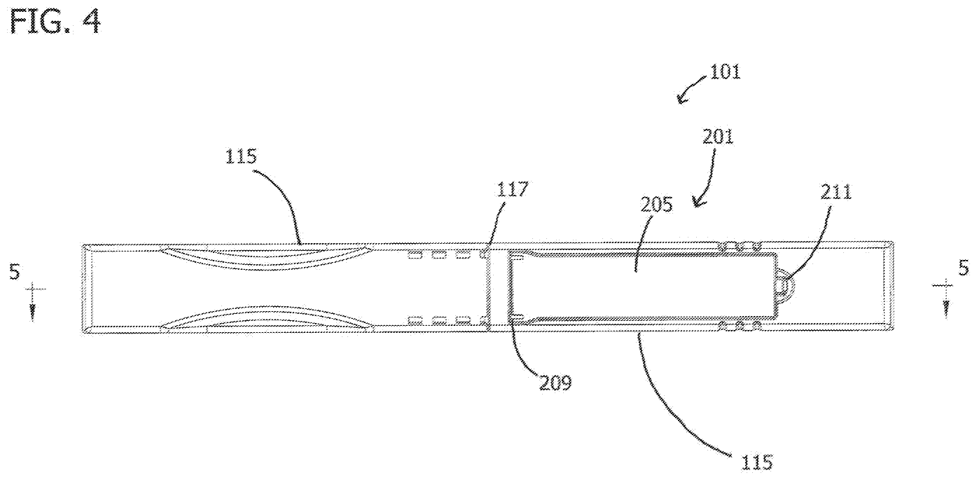

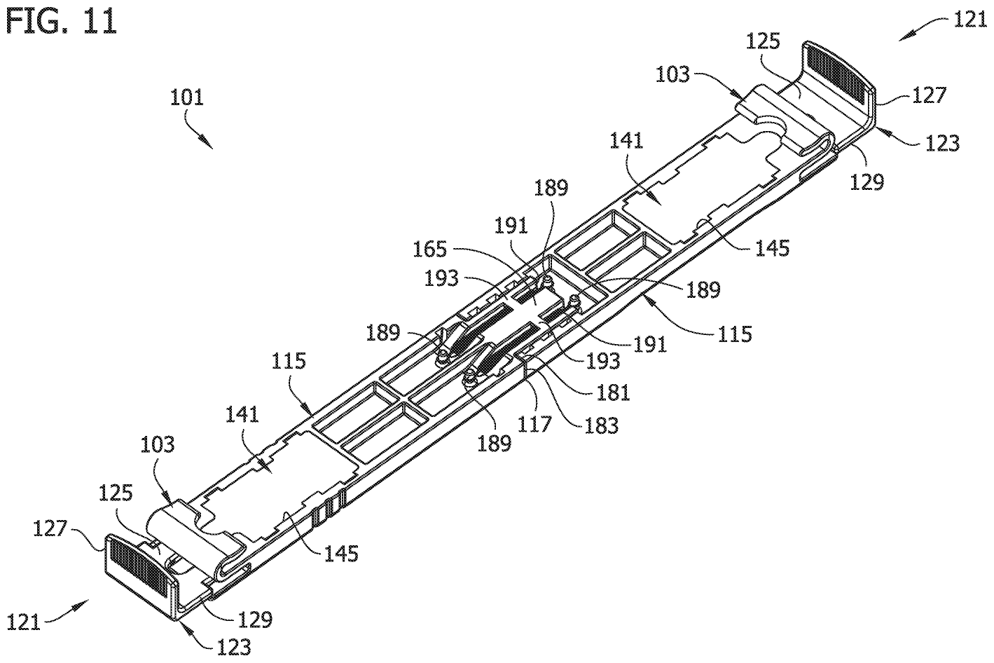

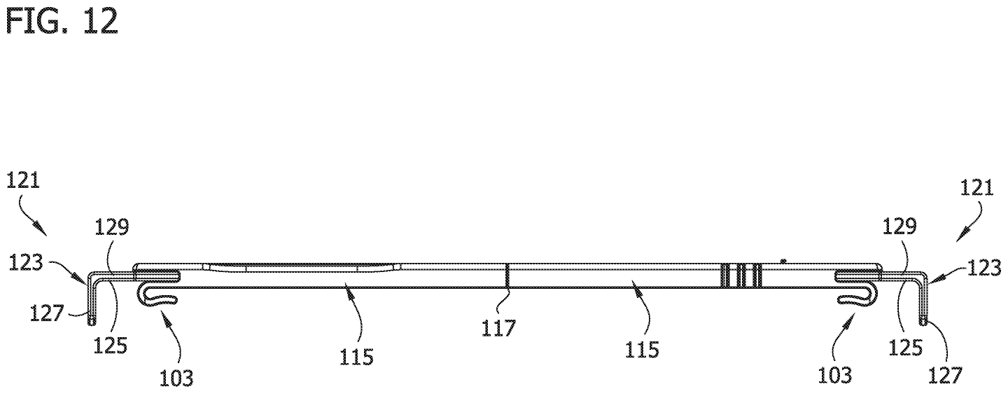

Referring first to FIGS. 1-15, one embodiment of a hanger for storing a notebook in a hanging file drawer system of the type including a pair of rails inside a drawer and extending between and supported by opposite sides of the drawer is generally designated 101. The hanger 101 has a pair of hooks 103 at opposite ends of the hanger for securing the hanger to a notebook to be suspended in the hanging file drawer system. The shape of the hooks 103 can vary as long as the hooks can each be secured to one end of a spine of a notebook cover in a manner to be described in more detail later.

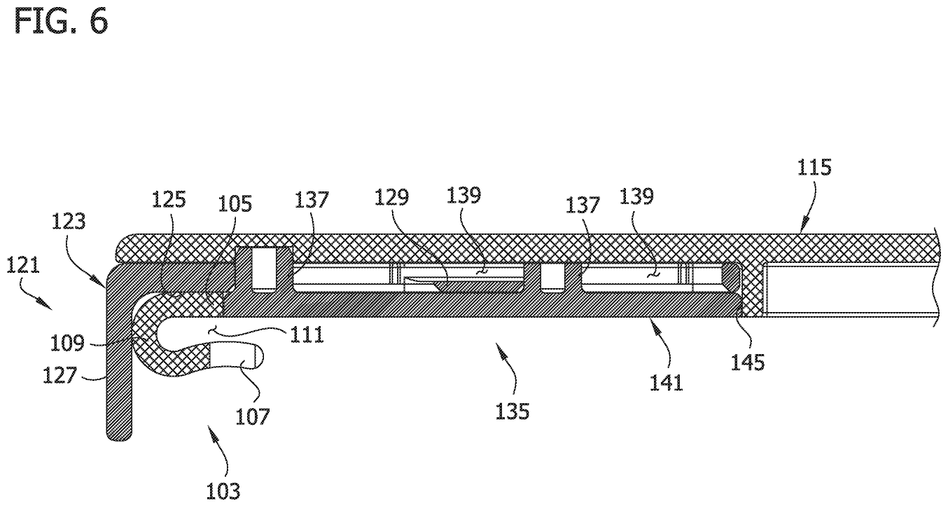

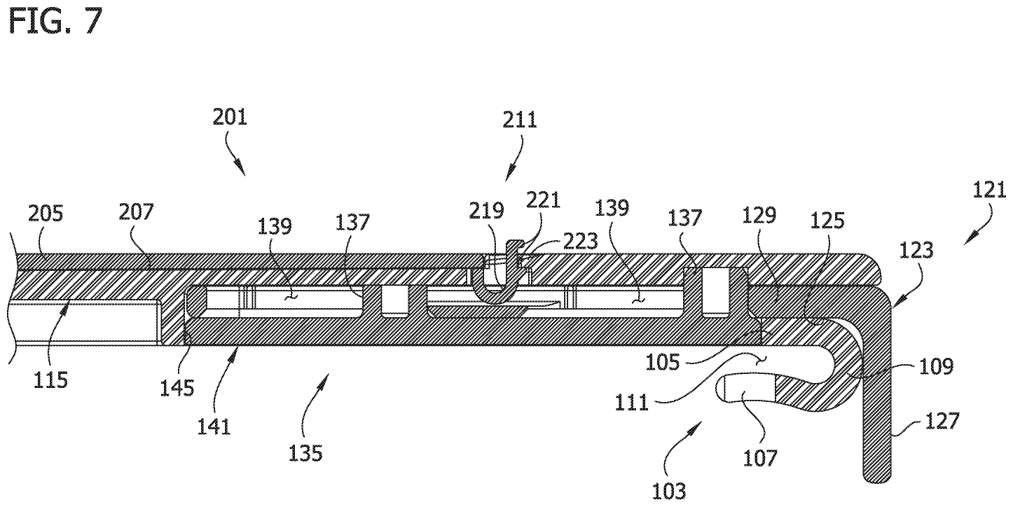

In the illustrated embodiment, the hooks 103 are substantially identical. However, it is understood that the hooks can have different shapes from one another if desired. Moreover, it is understood that the shape of the hooks can vary from the shape of the hooks illustrated herein. Referring to FIGS. 6 and 7, each of the hooks 103 has a shank 105 and an end 107 spaced from the shank. A bend 109 connects the shank 105 to the end 107 so that there is a space 111 between the shank and the end of the hook for receiving an edge of a notebook cover. In the illustrated embodiment, the ends 107 of each hook 103 flare away from the respective shank 105 at their distal ends to form a lead-in that facilitates entry of the notebook cover into the spaces 111. The shanks 105, ends 107, and bends 109 of the hooks 103 are suitably formed integrally as one-piece, e.g., in a molding process. However, various components of the hooks can be formed separately and secured to one another to form a hook if desired.

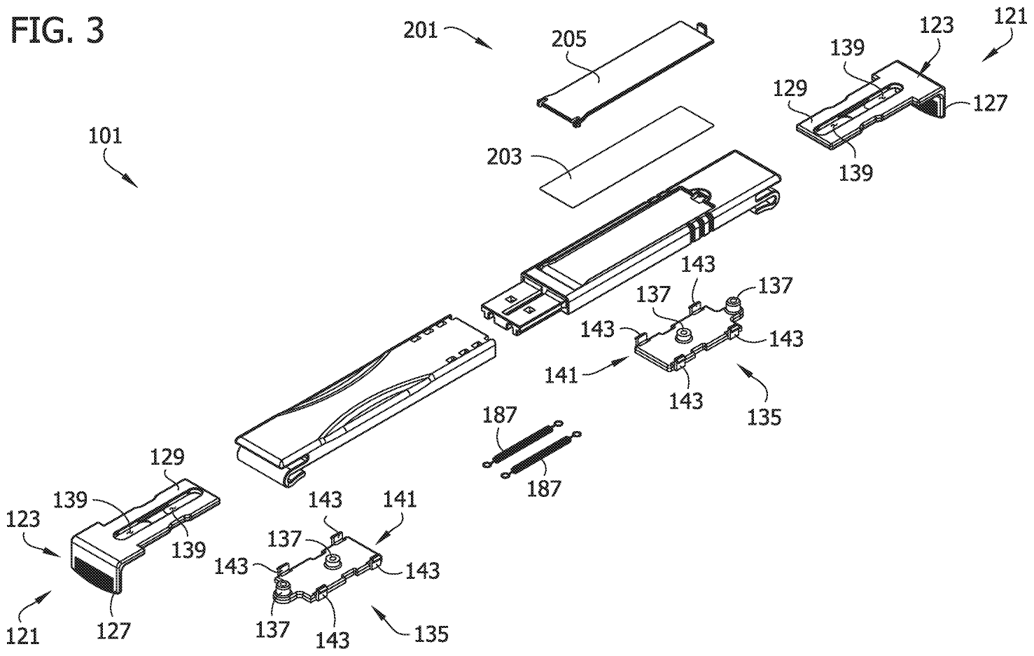

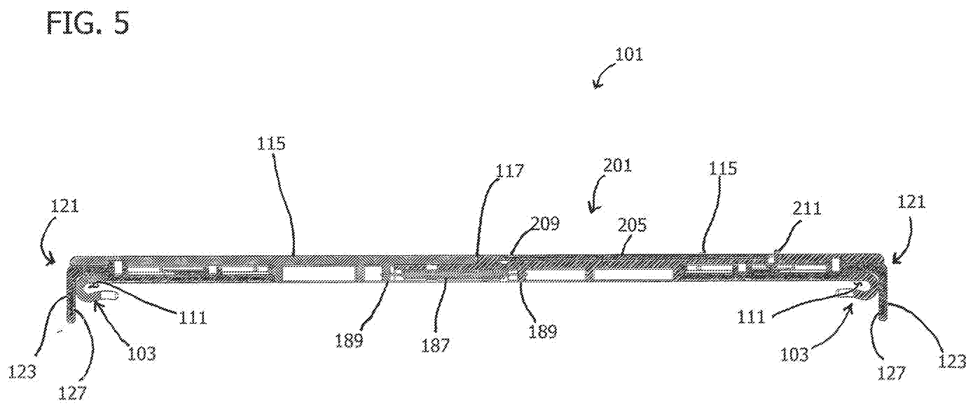

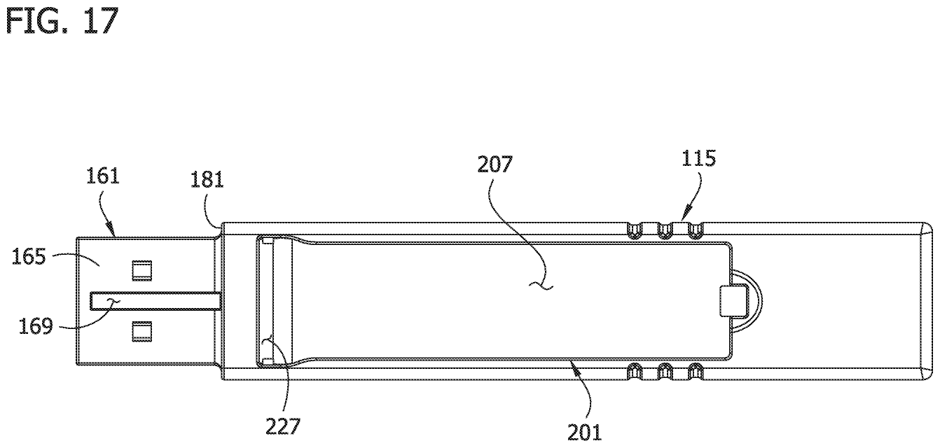

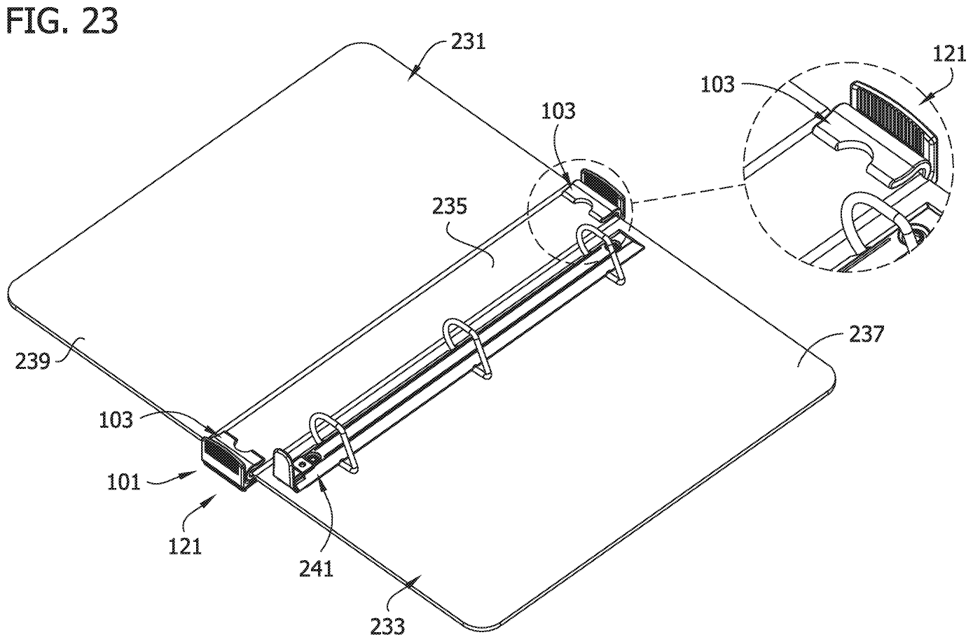

Each hook 103 in the illustrated embodiment is mounted at the end of an elongate member 115 (see FIGS. 3 and 16-20) that is configured to extend from the hook 103 along the back spine of a notebook when an edge of the notebook spine is received in the space 111 defined in the hook. For example, as illustrated in FIG. 5, the hanger 101 is suitably constructed so that substantially all structures that make up the hanger and that are positioned between the hooks 103 are offset from the spaces 111 defined by the hooks 103 and on the same side of the spaces as the shanks 105 of the hooks. In the illustrated embodiment the elongate members 115 each have a generally rectangular perimeter, although other shapes are possible. The hooks 103 are suitably secured at one end of the respective member 115. For example, the hooks 103 are suitably formed integrally with the respective member 115, such as by being molded together as one-piece in an injection molding system. The elongate members 115 are suitably configured so they extend from the respective hook 103 to an interface 117 that connects the hooks to one another. When the opposite upper and lower edges of a notebook spine are received in the hooks 103, the hanger 101 extends all the way from the upper edge of the notebook spine to the lower edge of the notebook spine along the back of the notebook spine. (See FIG. 23).

Referring to FIGS. 1-3, 6-7, and 10-12, the hanger 101 also includes a support system 121 that can be used to support the hanger and any notebook secured thereto on the rails of hanging drawer system. In the illustrated embodiment, the support system includes a pair of arms 123 at opposite ends of the hanger 101. Each arm 123 suitably includes a support surface 125 that can be positioned to engage one of the rails and a lip 127 extending angularly from the support surface.

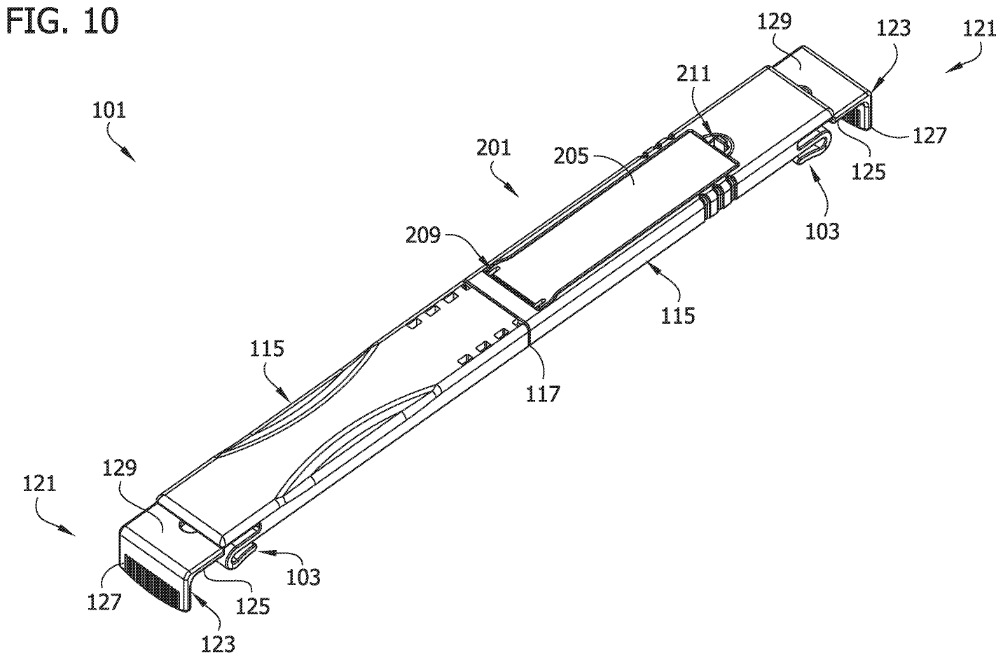

In the illustrated embodiment, the arms 123 are substantially identical to one another and a detailed description of one of the arms will suffice to describe them both. However, it is understood the arms could be different from one another. It is also understood that the arms could have different shapes from the arms described herein. Referring again to the illustrated embodiment each arm 123 is suitably selectively moveable between a retracted position (FIGS. 1-2, 4-7) and an extended position (FIGS. 10-12). The support surface 125 of each arm 123 extends laterally beyond the adjacent hook 103 when the arm is in the extended position. The lip 127 of each arm is spaced from the adjacent hook 103 by the support surface 125 when the arm is in the extended position. In the retracted position, the lip 127 of each arm 123 suitably abuts or is very closely adjacent the bend 109 of the adjacent hook 103. Referring to FIGS. 6 and 7, for example, each lip 127 suitably abuts an outer surface of the bend 109 of the adjacent hook 103 when the arms 123 are in their retracted positions.

Referring to FIGS. 3, and 6-7, the arms 123 suitably have an L-shaped configuration with the lip 127 forming a shorter segment of the L-shape. A longer segment 129 of the arm 123 extends from the lip 127 (e.g., substantially perpendicularly). In the illustrated embodiment, the longer segment 129 of the arm 123 is a substantially flat elongate plate. The portion of the longer segment 129 adjacent the lip 127 forms the support surface 125. The longer segment 129 of the arm 123 is suitably secured to the elongate member 115 of the adjacent hook 103 for sliding movement between the extended and retracted positions.

In the illustrated embodiment, the longer segments 129 of the arms 123 are received in pockets 131 (FIGS. 3, 16, and 19) formed in the ends of the elongate members 115 of the hanger 101. The portions of the arms 123 that are positioned in the pockets 131 are shielded from incidental contact that might inadvertently move the arms between the extended and retracted positions. The arms 123 and pockets 131 are configured so the lip 127 of each arm 123 cannot be received in the pocket. For example, the pockets 131 are suitably substantially rectangular pockets that generally conform in shape to the longer segment 129 of the arm 123. The entry into each pocket 131 is shaped so it cannot accommodate receiving the lip 127 of the arm 123 within the pocket. Thus, while at least some of the longer segment 129 of the arm 123 is always in the pocket 131 (more when the arm is retracted and less when the arm is extended), the lip 127 is always easily accessible from outside the pocket for manually moving the arm between the extended and retracted positions.

Referring to FIGS. 3 and 5-7, the hanger 101 suitably has a retaining system 135 that blocks movement of the arms 123 beyond the extended position and thereby retains at least some of the longer segments 129 of the arms in the pockets 131. In the embodiment illustrated in the drawings, the retaining system 135 includes a pair of stops 137 that extend transversely across each of the pockets 131. The stops 137 are suitably substantially cylindrical posts, as illustrated in FIGS. 3 and 5-7, although other shapes could be used if desired. The stops 137 suitably extend all the way from one side of the pocket 131 to an opposite side of the pocket (e.g., all the way from the top to the bottom of the pocket). The stops 137 are received in elongate slots 139 formed in the arms 123. The stops 137 slide relative to the arms 123 between opposite ends of the slots 139 as the arms move between their retracted and extended positions. When the arms 123 are in their extended positions (FIGS. 10-13), the stops 137 block further movement of the arms out of the pockets 131 because of their abutting relation with the ends of the slots 139.

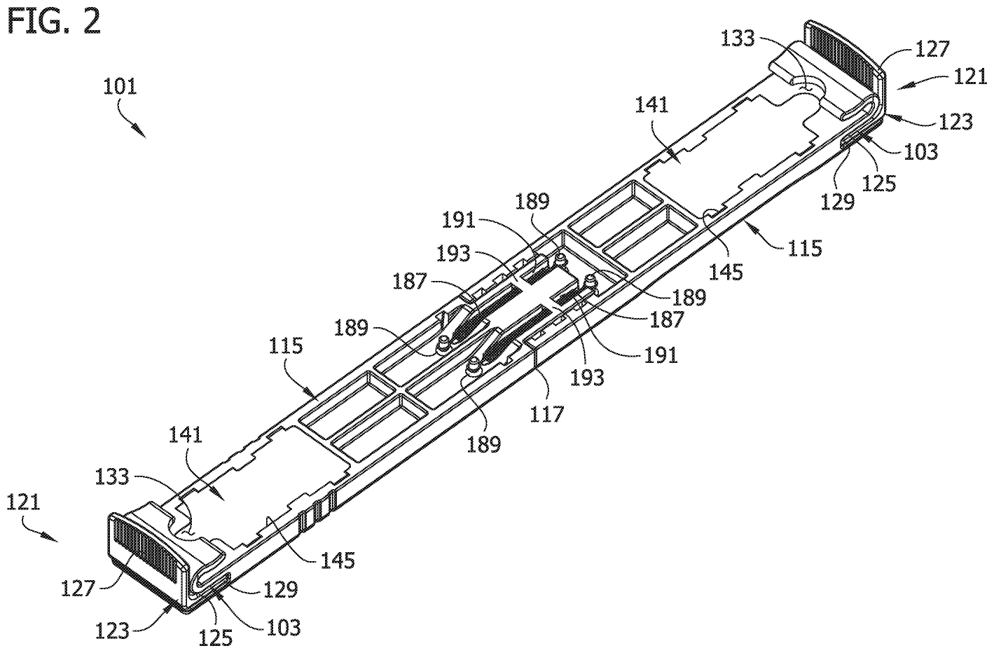

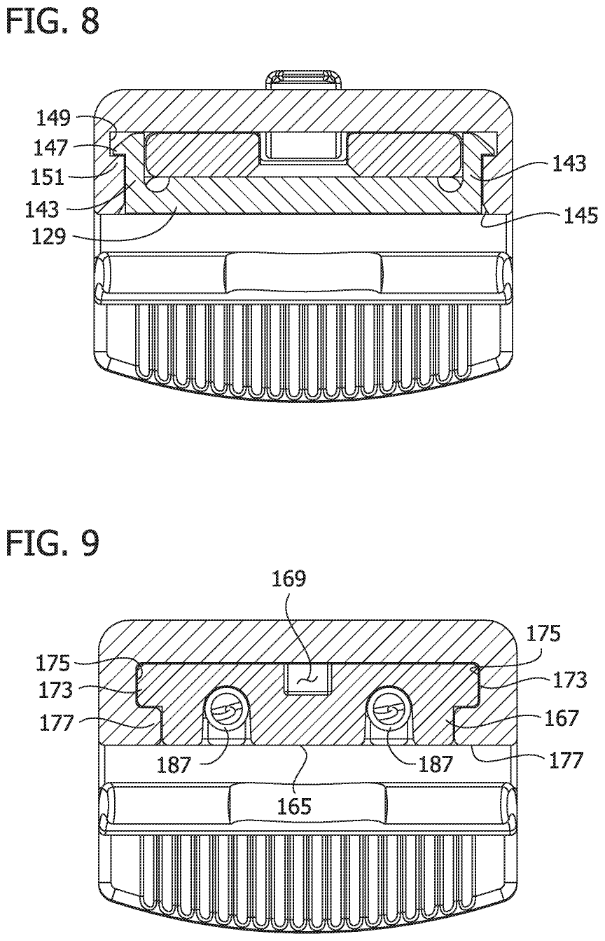

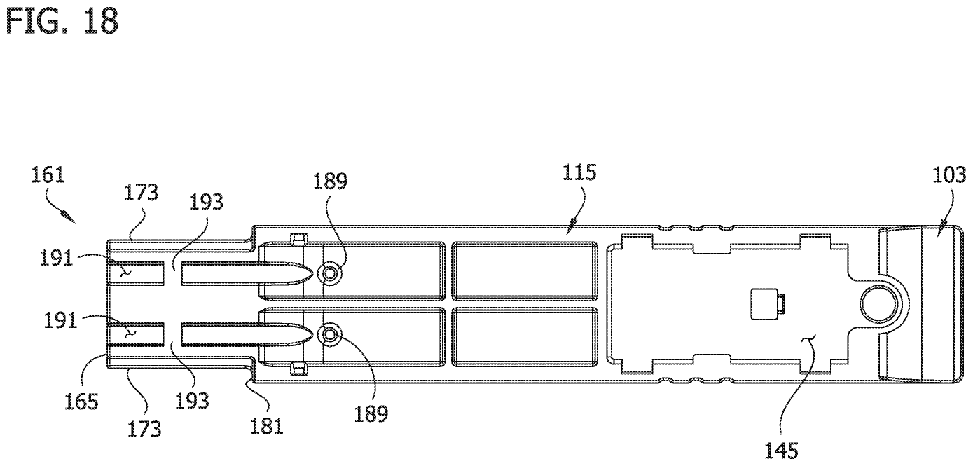

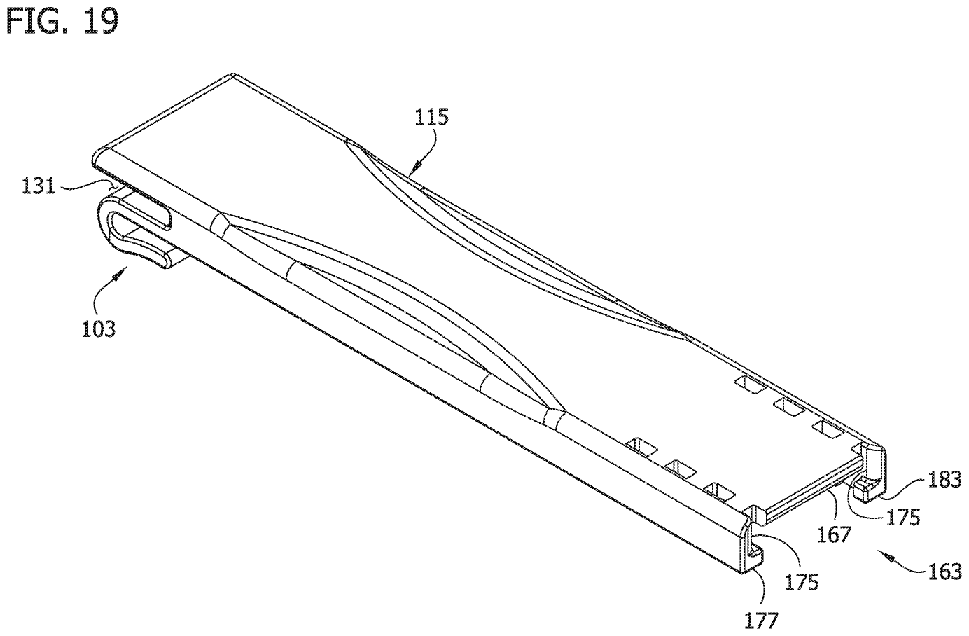

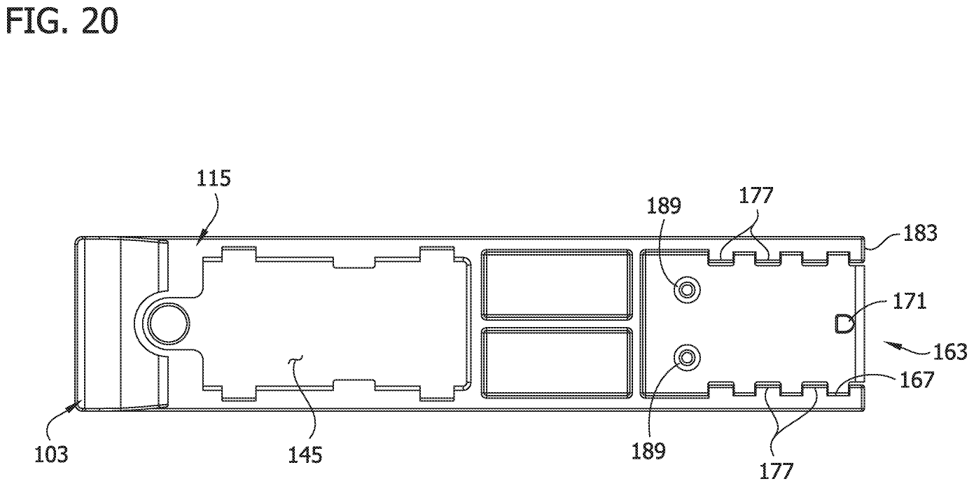

The stops 137 can be secured within the slots 139 in the arms 123 in various different ways. Referring again to FIGS. 2-3, 5-7, 11 and 13, for example, each pair of stops 137 is suitably mounted on a plate 141 that is secured to the respective elongate member 115. For example, the plates 141 are suitably configured to make a snap connection with the respective elongate member 115. The snap connection is suitably substantially irreversible, meaning there is no way to easily separate the plates 141 from their respective elongate member 115 in a non-destructive manner once they have been snapped together, as in the illustrated embodiment. The elongate members 115 suitably have a recessed area 145 (FIGS. 18 and 20) configured to receive one of the plates 141. The recessed area 145 is suitably generally in the form of a channel formed in the respective elongate member 115 so that the channel forms a portion of the pocket 131 for receiving the arms 123. The elongate members 115 and plates 141 are suitably configured so that the plates cover the open side of the respective channel when the plates are connected to the elongate members so that the plates and elongate members collectively form the pockets 131. Referring to FIG. 8, a portion of the recessed area 145 remains unoccupied by retaining system 135 to provide a sliding space within the hanger 101 for the longer segments 129 of the arms 123.

Each plate 141 in the illustrated embodiment has a set of resiliently deformable legs 143 (FIGS. 3 and 8) positioned at various locations on the plate. The legs 143 suitably extend from opposite sides of the plate 141 (e.g., substantially perpendicularly to the plate) and have retainers 147 that extend outward at their distal ends. The elongate members 115 and plates 141 are configured so that the legs 143 on each plate are resiliently deformed (e.g., bent inwardly) by the elongate members 115 at the outer perimeter of the respective recessed area 145 as the plate is being positioned in the recessed area. As each plate 141 is moved further into the recessed area 145, the retainers 147 on the ends of the legs 143 each move into alignment with a void space 149 (FIG. 8) that extends radially outward into the elongate member 115. The retainers 147 on the ends of the legs 143 are moved outward into the void spaces 149 by the restoration forces in the legs once the retainers are in alignment with the void spaces. The retainers 147 engage a shoulder 151 formed by the void spaces 149 when the plate 141 is fully seated within the recessed area 145.

Once the retainers 147 are in the void spaces 149, the shoulder 151 blocks movement of the legs 143 and the plate 141 out of the recessed area 145. The plates 141 and elongate members 115 are suitably configured so the outward-facing surface of each plate is substantially flush with a surface of the respective elongate member 115, as illustrated in FIGS. 2 and 5-7. Moreover, the outer perimeter of the recessed area 145 is suitably shaped to match the outer perimeter of the plate 141. There is no easy way for a person to move the retainers 147 out of the void spaces 149 once the plates 141 are fully snapped into connection with the elongate members 115 because of the lack of access to the retainers and void spaces from the exterior of the hanger 101. The retaining system 135 and elongate members 115 are suitably configured so movement of the plates 141 farther into the recessed area 145 is limited once the plates are snapped into connection with the elongate members. For example, referring to FIG. 8 the legs 143 are suitably positioned to block further movement of the plate 141 into the recessed area by engagement between the ends of the legs and the elongate member. This helps reduce the possibility of the plates 141 and elongate members 115 producing a clamping action that impedes movement of the arms 123 between the retracted and extended positions.

In the illustrated embodiment, the plates 141 and elongate members 115 are configured so the plates are positioned on the same sides of the elongate members 115 that are adjacent the notebook spine when the hanger 101 is secured to a notebook. However, it is understood that the plates and elongate member could be configured so the plates are on the opposite side of the hanger when they are secured to the elongate members if that is desired. It is also understood that the retaining system 135 illustrated herein could be replaced with a different type of retaining system if desired. For example, rivets or other fasteners could be extended through elongate slots in the arms to limit movement of the arms if desired.

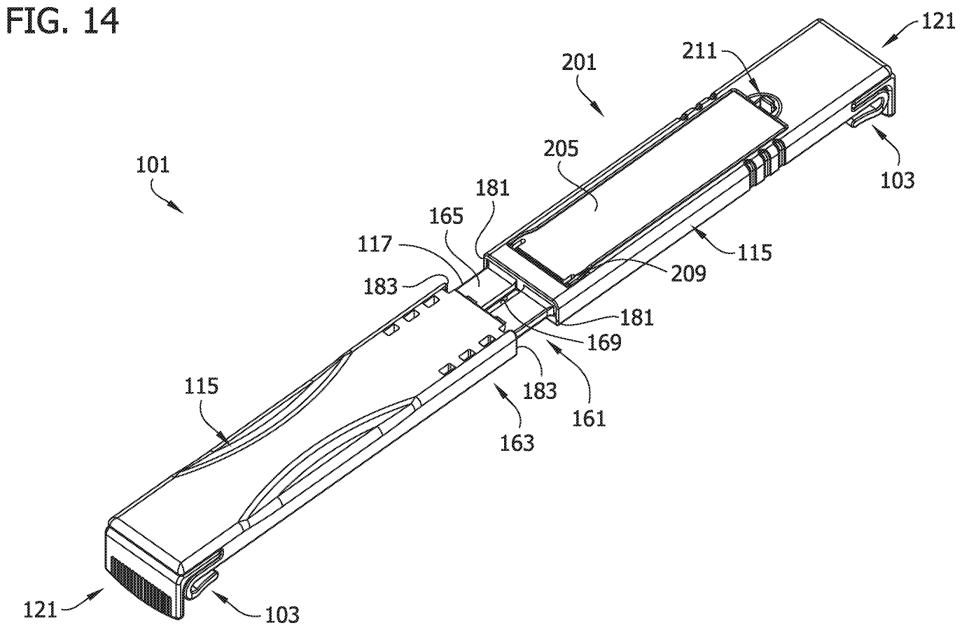

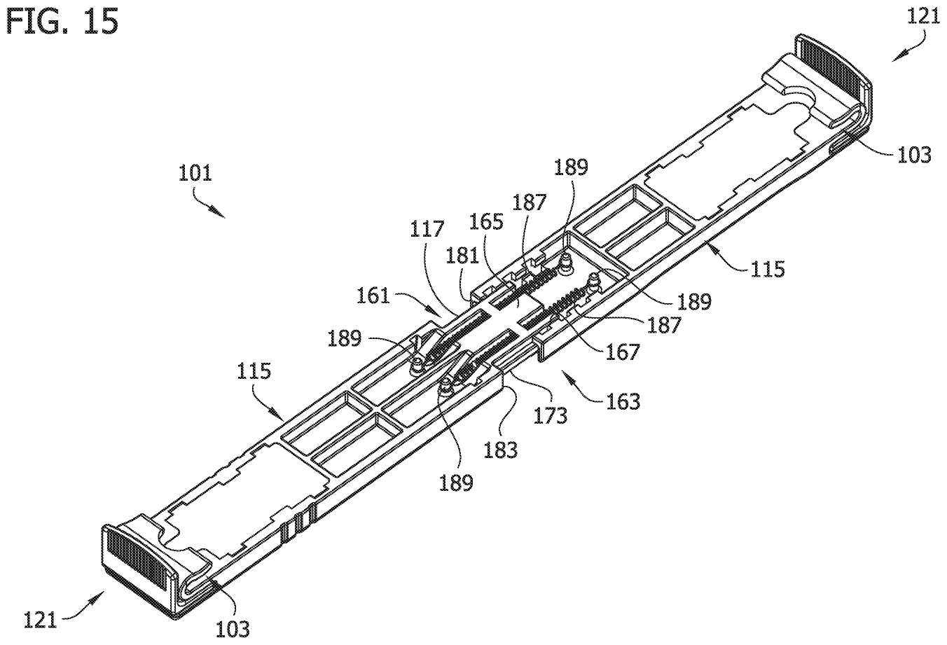

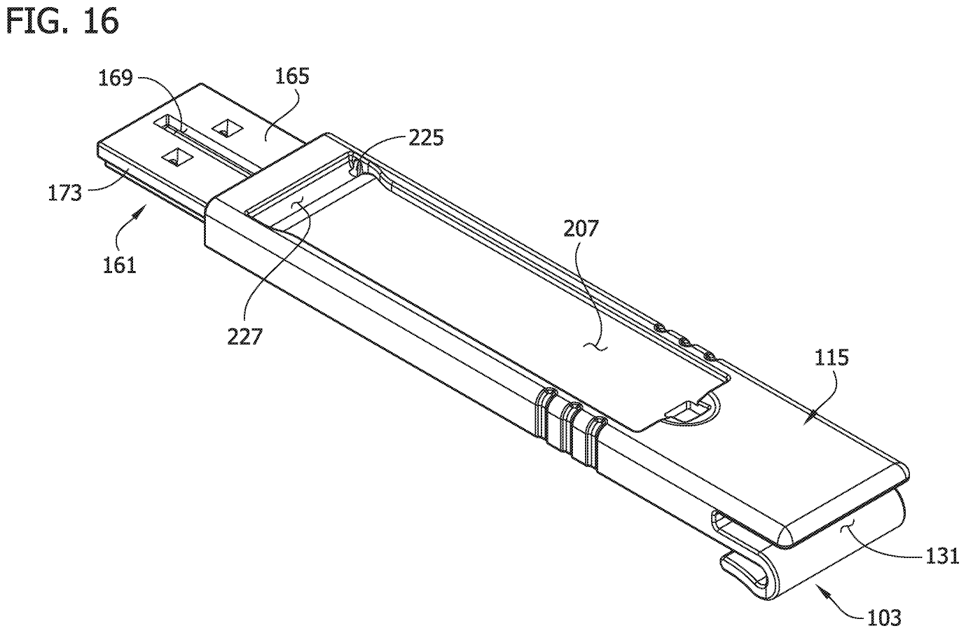

To facilitate mounting the hanger 101 on a notebook, in a manner that will be described in more detail below, the hanger suitably has a mechanism that allows the hooks 103 to move relative to one another between a first position (FIGS. 1-13), in which the hooks are spaced from one another about the same distance as the length of a notebook spine, and a second position (FIGS. 14 and 15) in which the hooks are spaced farther from one another than they are in the first position. Various mechanisms that allow movement of the hooks 103 relative to one another can be used. For example, in the illustrated embodiment the elongate members 115 to which the hooks 103 are secured are configured and arranged for sliding movement relative to one another between the first and second positions of the hooks. Referring to FIGS. 16-20 for instance, one of the elongate members 115 (FIGS. 16-18) suitably has a relatively narrower end 161 received within a relatively wider end 163 of the other elongate member (FIGS. 19-20) to form the interface 117 between the elongate members and allow telescoping sliding movement of the elongate members relative to one another.

The hanger 101 is suitably configured to substantially prevent non-destructive separation of the elongate members 115 from one another. In the illustrated embodiment, for example, the narrower end 161 of the elongate body 115 having the narrower end includes a projection 165 configured to fit within a channel 167 formed in the wider end 163 of the other elongate body. An elongate slot or channel 169 extends axially along the projection 165. A detent 171 (FIG. 20) on the elongate body 115 having the wider end 163 is positioned and arranged to extend into the channel 169. The elongate channel 169 does not extend all the way to the end of the projection 165 of the elongate member 115 having the narrower end 161. The detent 171 is suitably configured to have a beveled distal end oriented so the shortest portion of the detent faces the opposite elongate member 115 and the tallest portion of the detent faces away from the opposite elongate member. The beveled top of the detent 171 facilitates assembly of the hanger 101 by allowing a snapping action to be used to position the detent in the channel 169 of the opposite elongate member.

Referring to FIGS. 3 and 9, the projection 165 has flanges 173 extending along its sides which are received in corresponding grooves 175 formed in the sides of the elongate member 115 having the wider end 163 at the interface. The engagement of the flanges 173 and the grooves 175 restricts the ability to move the elongate members relative to one another in a direction that withdraws the detent 171 from the channel 169. The detent 171 can slide within the channel 169 as the elongate members 115 slide relative to one another to increase or decrease the distance between the hooks 103. However, engagement between the detent 171 and the end of the channel 169 adjacent the distal end of the projection 165 limits the extent to which the elongate members 115 can be moved away from one another. Because the taller portion of the detent 171 is the portion of the detent that contacts the end of the channel 169, the same snapping action that was used during assembly, which made use of the beveled top of the detent, will not be available to disconnect the elongate members 115 from one another. Instead, the engagement between the detent 171 and the end of the channel 169 substantially prevents non-destructive separation of the elongate member 115 from one another.

The hanger 101 is also constructed so the interface 117 limits the extent to which the hooks 103 can be moved toward one another. This can be helpful to limit the amount of compressive force that can be applied to a notebook supported by the hanger 101. For example, in the illustrated embodiment a shoulder 181 on the elongate member 115 having the narrower end 161 abuts the edge 183 of the elongate member having the wider end 163 when the hooks 103 are in the first position. The abutting engagement of the shoulder 181 on the narrow-ended elongate member 115 blocks further movement of the hooks 103 toward one another. Other configurations and arrangements of the elongate members could be used to limit the extent to which the hooks can be moved toward one another if desired.

The hanger 101 is suitably configured so the hooks 103 and elongate members 115 are biased toward the first position (in which the hooks are spaced more closely to one another). Referring to FIGS. 2-3, 5, 9, 11, and 15, for example, a biasing member 187 is positioned and arranged to resist movement of the hooks 103 (and elongate members 115) away from one another. The biasing member 187 is suitably a spring, such as a coil spring connected to each of the elongate members 115 and extending between the elongate members across the interface 117. For example, the ends of the spring 187 are suitably connected to posts 189 on the elongate members 115 so that the spring stretches as the elongate members 115 are moved away from one another. In the illustrated embodiment, the spring 187 has a preload so that the biasing forces are more uniform over the entire range of motion of the elongate members 115. In the illustrated embodiment, for example, the posts 189 on which the spring 187 is mounted are positioned far enough away from one another that the spring is already in a stretched configuration when the elongate members are in abutting relation to one another and the hooks 103 are in their first position (in which they are closer to one another).

In the illustrated embodiment, there are two springs 187 which are substantially identical. The springs 187 extend through channels 191 formed in the projection 165 on the end of the elongate member 115 having the narrow end 161. A retainer 193 extends over the open side of each channel 191 to hold the springs in the channels and limit the risk that the ends of the springs will slip off the posts 189 on which they are mounted. Use of two springs 187 facilitates positioning the springs in a position that is offset from the central longitudinal axis of the hanger (e.g., to avoid positioning the spring in the same place as the detent 171 and channel 169 for the detent). It is possible to use a single offset spring if desired. However, use of two offset springs 187 on opposite sides of the sliding axis of the elongate members 115 distributes the biasing forces more evenly and can result in smoother sliding action of the elongate members. In contrast, a single offset spring may produce unbalanced bending moments of the type that can result in binding action that opposes the telescoping sliding movement of the elongate members 115. However, it is understood that a single biasing member can be used, including a single spring (whether on the central axis or offset from the central axis), without departing from the scope of the invention. It is also understood that the biasing member can be omitted if desired (e.g., using friction to hold the hooks 103 in the desired position).

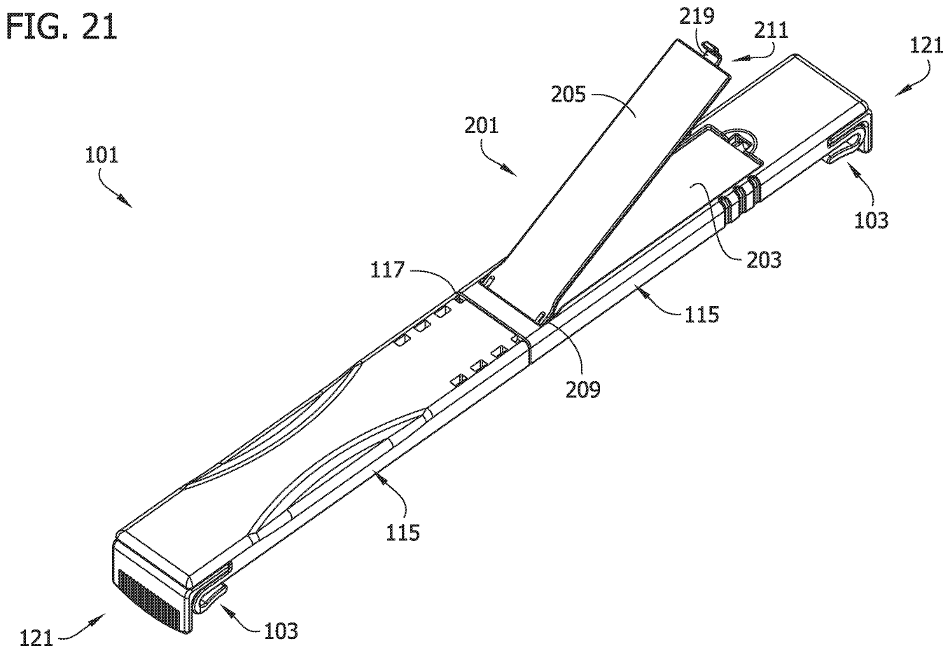

The hanger 101 suitably also includes label display system 201 that facilitates display of a label 203 containing information about the contents of a notebook supported by the hanger. For example, the label display system 201 is suitably configured to releaseably secure a label 203 (FIGS. 3 and 21) to the hanger in a manner in which the label is visible while the hanger is supporting a notebook without use of any adhesive to secure the label to the hanger. In the illustrated embodiment, the label display system 201 includes a transparent structure 205 (broadly a “label cover”) positioned and arranged to hold the label 203 on the hanger 101 between the transparent structure and other parts of the hanger 101. For instance, the transparent structure 205 suitably holds the label 203 between the transparent structure and one of the elongate members 115.

Referring to FIGS. 1, 3, 7, 13 and 21-22, for example, the transparent structure 205 is suitably a door made of a transparent material (e.g., a transparent polymeric material). The door is selectively moveable between a closed position (FIGS. 1 and 7) in which the door substantially covers a label receptacle 207 formed in one of the elongate members 115 for receiving the label 203 and an open position (FIG. 21) in which the receptacle is at least partially exposed for adding, removing, and/or replacing labels. The door 205 is suitably mounted for pivoting movement on a hinge 209 connecting one end of the door to one of the elongate members 115 at an end of the label receptacle 207. A latch 211 is configured to releasably secure the opposite end of the door to the same elongate member 115. In the illustrated embodiment, the door 205 is connected to the elongate member 115 that has the narrower end 161 at the interface. However, the door could be mounted on the other elongate member if desired.

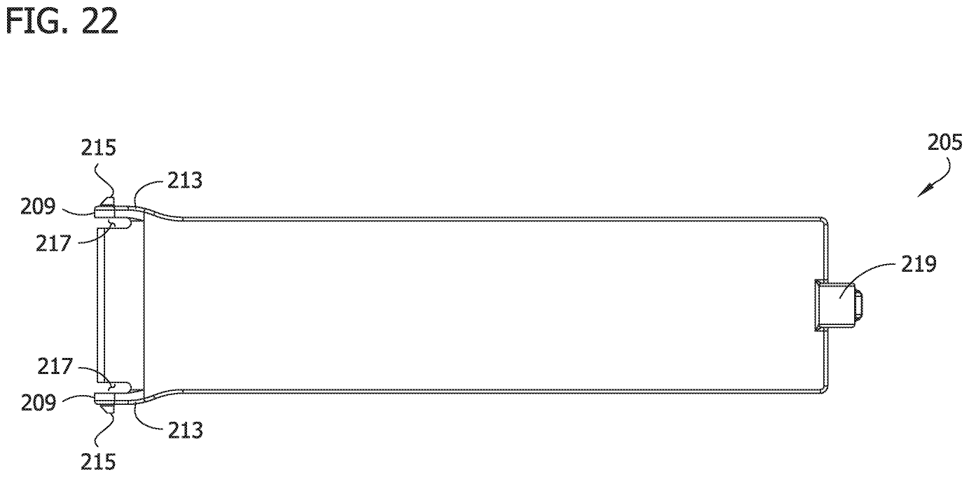

The hinge 209 and latch 211 are suitably formed integrally with the door 205 and elongate member 115. The door 205 and elongate member 115 are suitably configured so that the door can be snapped directly into a hinged connection with the elongate member. Referring to FIG. 22, for example, the door 205 suitably has a pair of arms 213 at the end having the hinged connection with the elongate member. The arms 213 are suitably formed integrally as one-piece with the rest of the door 205 (e.g., by the entire door being molded as one-piece). The ends of the arms 213 are suitably separated from the rest of the door 205 by longitudinally extending slots 217 extending in from the end of the door. This facilitates flexing at the distal ends of the arms 213. Beveled detents 215 extend outward from the arms 213. Referring to FIG. 16, the elongate member 115 has openings 225 on opposite sides of the label receptacle 207 at the hinge connection 209 for receiving the beveled detents 215 on the door 205.

During assembly of the hanger 101, the door 205 can be snapped into hinged connection with the elongate member 115 by inserting the arms 213 of the door into the space between the openings 225 at the end of the label receptacle 207. The arms 213 flex inwardly to allow the detents 215 to fit between the opposite sides of the label receptacle 207. As detents 215 move into alignment with the openings 225, the arms 213 move toward their un-deformed configuration and drive the detents 215 into the openings 225, thereby snapping the door 205 into a hinged connection with the elongate member 115. Referring to FIG. 16, there is suitably a depression 227 at one end of the label receptacle 207 to provide clearance for the end of the door 205 in the open position.

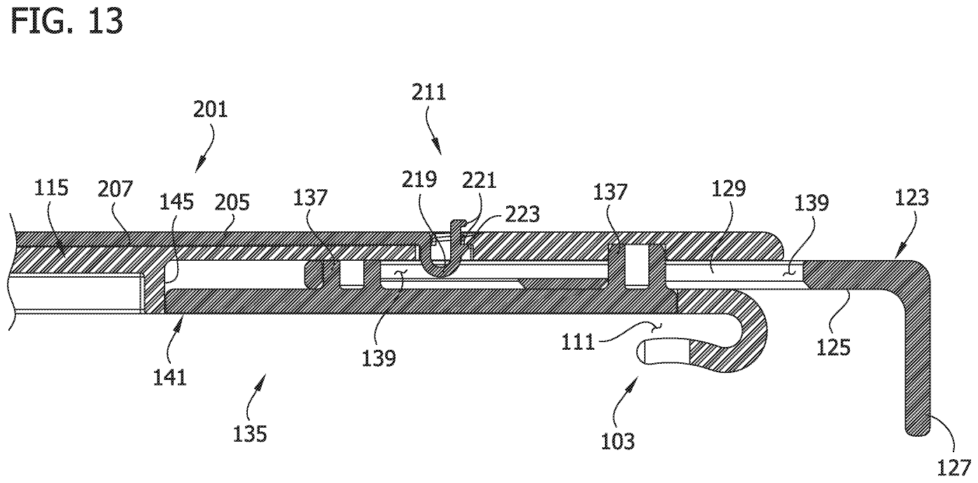

Referring to FIGS. 7 and 13, the door 205 and elongate member 115 are suitably configured so the end of the door opposite the hinge 209 can be releasably secured directly to the elongate member. In the illustrated embodiment, for instance, the door includes a generally U-shaped leaf spring 219 at the end of the door opposite the hinge 209. The leaf spring 219 is suitably formed integrally with the door 205 (e.g., by being molded as one-piece with the rest of the door). A pair of retainers 221 extend outward from the distal end of the leaf spring 219. The retainers 221 are positioned so when the door 205 is in the closed position the retainers can engage a lip 223 on the elongate member 115 extending into the label receptacle 207. One of the retainers 221 is suitably above the lip 223 when the door 205 is closed while the other retainer is below the lip. This allows the retainers 221 to block opening movement of the door 205 while also blocking over-rotation of the door in the closing direction, which could undesirably make it difficult to open the door. To open the door 205, a user presses against the leaf spring 219 to deform it until the retainers 221 disengage the lip 223. Once the retainers 221 are disengaged from the lip 223, the retainers no longer block pivoting movement of the door 205 on the hinge 209, which can be pivoted by the user to the open position.

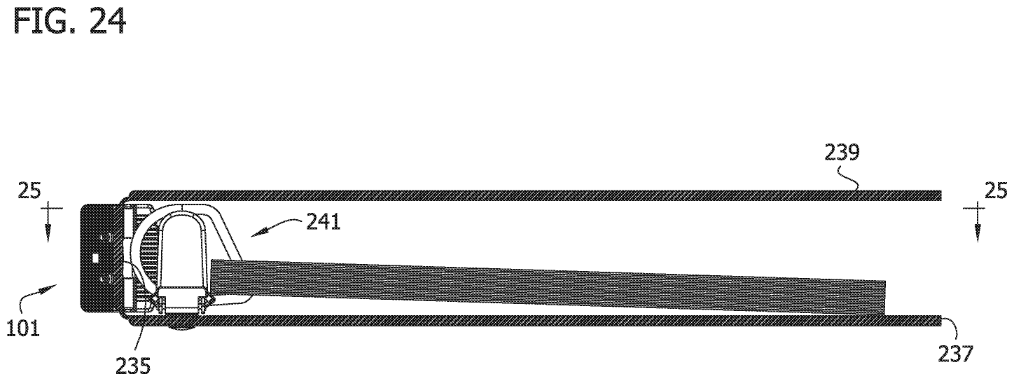

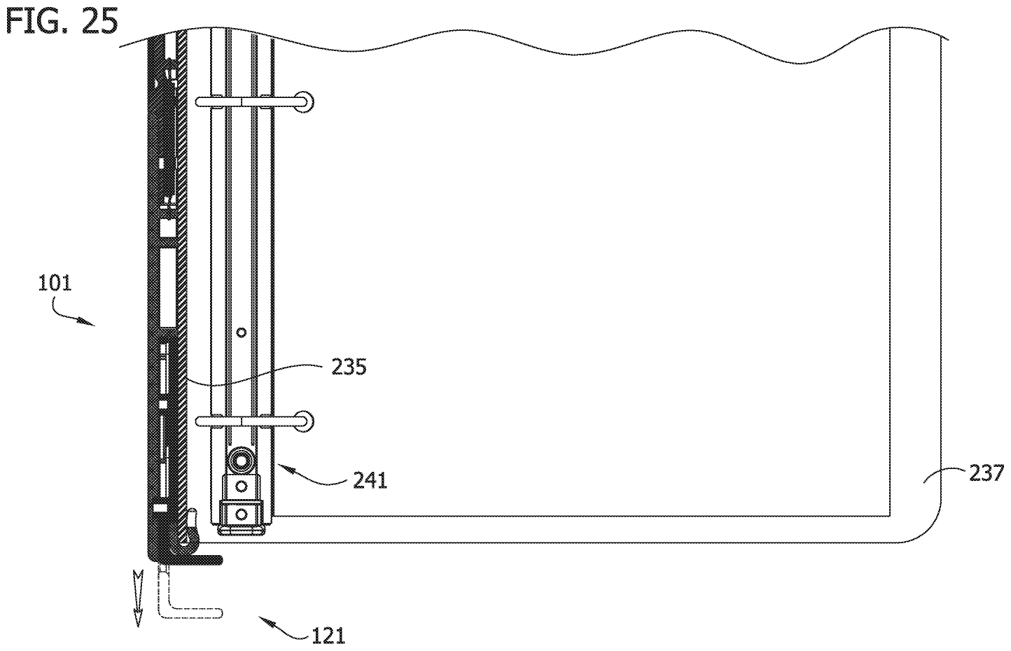

FIGS. 23-25 show one embodiment of the hanger 101 in combination with a notebook 231. The notebook 231 includes an outer cover 233 including a spine 235 and front and back covers 237, 239 hingedly secured to the spine. The hooks 103 of the hanger 101 are secured to the spine 235 of the notebook cover 233. In particular, the upper and lower edges of the spine 235 are in the spaces 111 defined by the hooks 103. The notebook 231 also includes a ring binder mechanism 241 mounted on the back cover 239 adjacent the spine 235. Because the hanger 101 does not require any engagement or interaction with the ring binder mechanism 241 to remain secured to the notebook 231, there is no need for the ring binder mechanism to be mounted on the spine 235 of the notebook. Thus, the hanger 101 can be secured to the notebook 231 independently of the choice for the position of the ring binder mechanism 241 on the notebook 231 (on the spine vs. on one of the covers adjacent the spine).

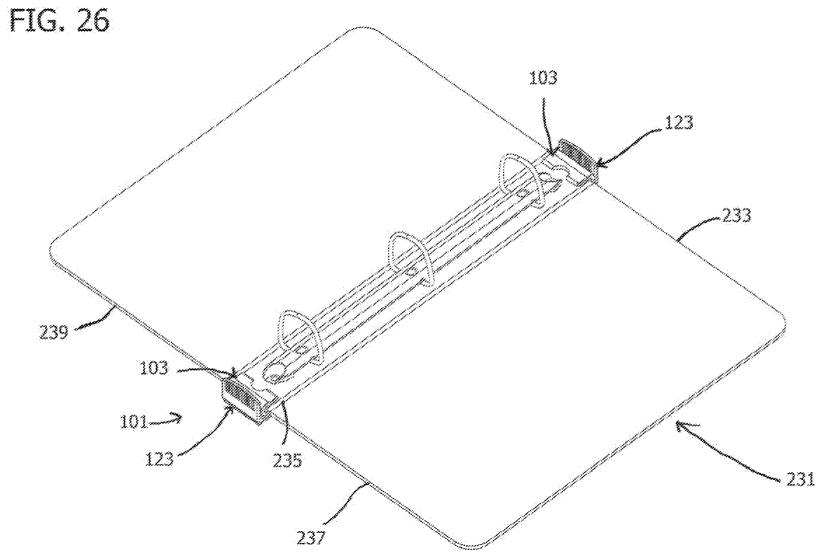

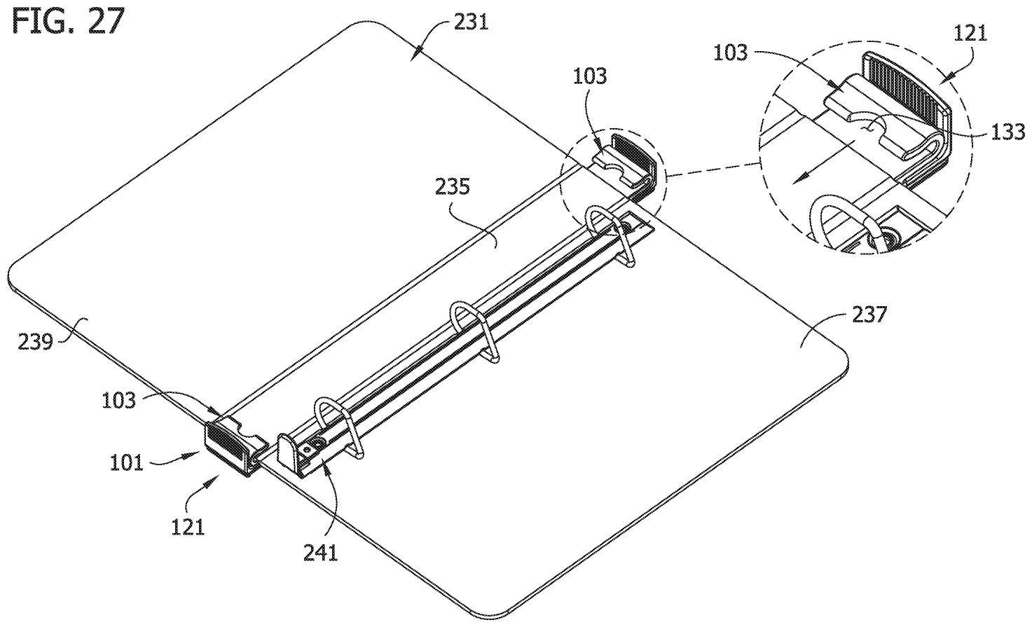

As illustrated in FIG. 26, it is also possible to secure the hanger to the spine 235 when a ring binder mechanism 241 is secured to the spine instead of to the cover adjacent the spine. It is possible that the ends of some ring binder mechanisms may interfere with the ability to extend the hooks 103 over the edges of the spine 235. However, in many cases it will be possible to insert the ends 107 of the hooks 103 between the ring binder mechanism 241 and the spine 235. One possible obstruction is the rivets or other fasteners that may be used to secure the ring binder mechanism 241 to the spine 235. The ends 107 of the hooks 103 suitably have cutouts 133 formed therein. The cutouts 133 are sized and positioned so rivets or other similar fasteners securing the ring binder mechanism 241 to the spine may be received in the cutouts to reduce the likelihood of obstruction.

Although, the hanger 101 can be secured to the spine 235 even though a ring binder mechanism 241 is also secured to the spine in many cases, it is understood that there may be some ring binder mechanisms having configurations that prevent a secure connection between the hanger and the spine when that particular size and shape of ring binder mechanism is secured to the spine. However, various modifications can be made to the size and shape of the hooks to adapt the hanger for use with ring binder mechanisms that obstruct securement of the particular hanger 101 illustrated herein to the spine when those particular ring binder mechanisms are secured to the notebook spine.

One embodiment of a method of storing a notebook 231 in a hanging drawer system will now be outlined. The hanger 101 is secured to the notebook cover 233 by securing one of the hooks 103 to a first end of the notebook spine 235 and securing the other hook to the opposite end of the spine. For example, the hooks 103 are suitably moved away from one another against the force of springs 187 or other biasing member(s), as illustrated in FIG. 27 to place the hooks over the ends of the spine 235. Then the hooks 103 are moved toward one another, as illustrated by the arrow in FIG. 27, until the ends of the spine 235 are received in the hooks, as illustrated in FIG. 23. If desired, the hanger 101 may be secured to the spine 235 of the notebook 231 without using any part of any ring binder mechanism that may be secured to the notebook cover 233 to secure the hanger to the notebook. The hanger 101 does not rely on any engagement with the ring binder mechanism to make a secure connection with the notebook.

In one embodiment of this method, the notebook 231 has a ring binder mechanism 241 mounted on the spine (as in FIG. 26). In another embodiment of this method, the notebook 231 has a ring binder mechanism 241 mounted on one of the covers 237 adjacent the spine 235 (as in FIG. 23). Because the hanger 101 can in many cases be secured to the notebook cover 233 regardless of the position of the ring binder mechanism 241, it is usually not necessary to be concerned about the position of the ring binder mechanism when selecting a hanger to use to support a particular notebook.

Optionally, the door 205 of the label display system 201 is unlatched and moved to its open position (FIG. 21). A label 203 containing information about the contents of the notebook 231 is placed in the label receptacle 207. Then the door 205 is closed to hold the label 203 in the receptacle 207 so the label is visible through the transparent door.

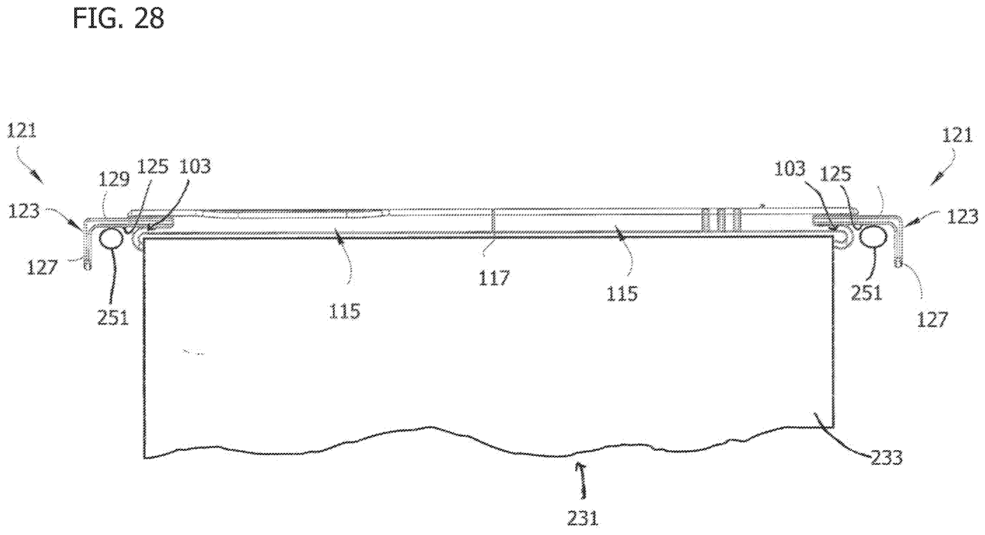

The arms 123 of the hanger are moved from their retracted positions (FIGS. 1 and 2) to their extended positions (FIGS. 10-12). Then the notebook 231 and hanger 101 combination is placed in the drawer so that the support surfaces 125 of the arms sit on the rails 251 of the hanging drawer system, as illustrated in FIG. 28, and the rails support the hanger and notebook. In most cases, the hanger 101 and notebook 231 will be completely suspended by the rails. However, this will depend on the size and shape of the drawer and the notebook 231 and it is understood the notebook may partially rest on a lower surface of the drawer without departing from the scope of the invention.

If it is desired to re-use the hanger 101 to support a different notebook 231, the hanger is separated from the notebook by moving the hooks 103 away from one another against the bias of the biasing member(s) 187 so that at least one edge of the notebook spine 235 is withdrawn from the space 111 in the respective hook 103. Then the other hook 103 can easily be detached from the opposite end of the notebook spine 235. The process can be repeated to secure the hanger 101 to the next notebook. If desired, the label 203 can easily be replaced with a different label by opening the door 205 and replacing the label.

As used herein, all terms indicating a particular orientation (e.g., up, down, etc.) are not limiting. The hangers and notebooks described herein can be re-oriented in any manner without departing from the scope of the invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatuses, systems, and methods without departing from the scope of the invention, it is intended that all matter contained in the above description and shown in the accompanying drawings shall be interpreted as illustrative and not in a limiting sense.

What is claimed is:

1. A hanger for hanging a binder containing loose-leaf pages in a hanging drawer system of the type comprising a pair of rails inside the drawer and extending between opposite sides of the drawer, the hanger comprising:
a first hook configured to be secured to one end of a spine of the notebook;
a second hook opposed to the first hook and configured to be secured to an opposite end of the spine of the notebook;
a first arm moveable relative to the first hook between a retracted position and an extended position, the first arm having a support surface and a lip extending angularly from the support surface, the support surface of the first arm extending laterally beyond the first hook when the first arm is in the extended position, the lip of the first arm being spaced from the first hook by the support surface of the first arm when the first arm is in the extended position; and
a second arm moveable relative to the second hook between a retracted position and an extended position, the second arm having a support surface and a lip extending angularly from the support surface, the support surface of the second arm extending laterally beyond the second hook when the second arm is in the extended position, the lip of the second arm being spaced from the second hook by the support surface of the second arm when the second arm is in the extended position.

2. A hanger as set forth in claim 1 wherein the first and second hooks are connected to one another.

3. A hanger as set forth in claim 2 further comprising a biasing member positioned and arranged to resist movement of the hooks away from one another.

4. A hanger as set forth in claim 1 comprising first and second elongate members wherein the first hook is secured to the first elongate member and the second hook is secured to the second elongate member and the first and second elongate members are configured and arranged for sliding movement relative to one another.

5. A hanger as set forth in claim 4 wherein the first and second elongate members are configured and arranged for telescoping movement relative to one another.

6. A hanger as set forth in claim 4 wherein the first and second hooks each comprise a shank, an end spaced from the shank, and a bend connecting the shank to the end so that there is a space between the shank and the end of the hook for receiving an edge of the notebook, and wherein the first and second elongate members are configured to extend along the outer spine of the notebook when the upper and lower edges of the spine are received in the spaces between the shanks and the ends of the hooks.

7. A hanger as set forth in claim 4 further comprising a biasing member configured and arranged to resist movement of the first and second elongate member away from one another.

8. A hanger as set forth in claim 7 wherein the biasing member comprises a spring connected to the first and second elongate members.

9. A hanger as set forth in claim 8 wherein the spring has a preload when the first and second elongate members are in abutting relation to one another.

10. A hanger as set forth in claim 1 further comprising a label cover made of a transparent material and selectively moveable between a closed position and an open position, the label cover being positioned in the closed position to cover a receptacle for receiving a label, the label cover being positioned in the open position to expose the receptacle for placing a label in the receptacle.

11. A hanger as set forth in claim 1 wherein the arms are received in pockets formed at opposite ends of the hanger.

12. A hanger as set forth in claim 11 comprising first and second elongate members wherein the first hook is secured to the first elongate member and the second hook is secured to the second elongate member, the first and second elongate members having channels formed therein that receive the arms and partially form the pockets, the hanger further comprising plates secured to the first and second elongate members and positioned to cover the channels and the portions of the arms received therein.

13. A hanger as set forth in claim 12 wherein the plates are configured to be connected to the first and second elongate members by a snap connection.

14. A hanger as set forth in claim 12 wherein the arms have an elongate slot formed therein, the hanger further comprising a retainer secured to each of the arm covers and extending through the slot in the respective arm for restricting movement of the arms beyond the extended positions.

15. A hanger as set forth in claim 1 in combination with a notebook having a notebook cover including a spine having opposite ends, the hanger being secured to the notebook by engagement of the first and second hooks with the opposite ends of the spine.

16. A hanger and notebook combination as set forth in claim 15, wherein the notebook comprises a ring binder mechanism mounted on the cover adjacent the spine.

17. A hanger and notebook combination as set forth in claim 15, wherein the notebook comprises a ring binder mechanism mounted on an inner surface of the spine.

18. A method of storing a notebook including a notebook cover having a spine in a hanging drawer storage system of the type having a pair of rails mounted inside a drawer, the method comprising:
securing a hanger having first and second hooks to the notebook cover by securing the first hook to one end of the spine and securing the second hook to an opposite end of the spine;
moving a first arm of the hanger from a retracted position to an extended position, the first arm having a support surface and a lip extending angularly from the support surface, the support surface of the first arm extending laterally beyond the first hook when the first arm is in the extended position, the lip of the first arm being spaced from the first hook by the support surface of the first arm when the first arm is in the extended position;
moving a second arm of the hanger from a retracted position to an extended position, the second arm having a support surface and a lip extending angularly from the support surface, the support surface of the second arm extending laterally beyond the second hook when the second arm is in the extended position, the lip of the second arm being spaced from the second hook by the support surface of the second arm when the second arm is in the extended position; and
placing the support surfaces of the first and second arms on the rails so the hanger and notebook are supported by the rails.

19. A method as set forth in claim 18 wherein securing the first and second hooks to opposite ends of the spine comprises moving the hooks away from one another against the force of biasing member to place the hooks over the ends of the spine and then moving the hooks toward one another so the ends of the spine are received in the hooks.

20. A method as set forth in claim 18 wherein the notebook comprises a ring binder mechanism, the method comprising securing the hanger to the notebook without using any part of the ring binder mechanism to secure the hanger to the notebook.
